(19) United States
(12) Patent Application Publication
(10) Pub. No.: US 2011/0074578 A1
(43) Pub. Date: Mar. 31, 2011

(54) FACILITIES MANAGEMENT FOR AN AUTOMATED INTERACTIVE CUSTOMER INTERFACE FOR AN AUTOMOTIVE FACILITY

(76) Inventor: Tim Yablonowski, Naples, FL (US)

(21) Appl. No.: 12/568,580

(22) Filed: Sep. 28, 2009

(51) Int. Cl. G08B 13/00

(52) U.S. Cl. 340/541

(57) ABSTRACT

A system for managing exterior lighting levels and for communicating with intruders and potential customers after hours at an automotive sales and/or service facility. The system has sensors for monitoring the premises for human activity after hours. Lighting levels may be raised and lowered responsively to sensed intrusions. A speaker may warn intruders of consequences, and identify and assist customers who wish to conduct after hours activities at an automated interactive interface device. The interactive interface device may accept manually input data to initiate purchase and service transactions, and may establish live connection to remote security service personnel.

### REFERENCE TO RELATED APPLICATION

The present application is related to a copending application entitled CUSTOMER INTERACTION MANAGEMENT FOR AN AUTOMATED INTERACTIVE CUSTOMER INTERFACE FOR AN AUTOMOTIVE FACILITY, filed of even date herewith. The copending application is hereby incorporated in its entirety herein by reference.

### FIELD OF THE INVENTION

The present invention relates to an automated automotive sales and service facilities which may be unstaffed at times when customers are present, and more particularly, to a system for managing illumination, electrical consumption, security, and automated customer greeting and direction at such an automotive facility.

### BACKGROUND OF THE INVENTION

Automotive facilities such as retail dealers, leasing dealers, and repair facilities ordinarily maintain business hours during which these facilities are staffed. During ordinary building hours, facility personnel are present to receive customers and potential customers and to perform the operations of the facility. These operations may involve commercial transactions for providing automobiles, such as sales of new and old cars, and leasing automobiles. The operations may also involve providing repair and maintenance services to customers who own or lease automobiles.

Whenever personnel are present at an automobile facility, any one individual or even several individuals are susceptible to being busy at a time when a new customer comes to the premises to buy, lease, or service an automobile. This creates inconveniences for both the customers and for the service personnel at the automobile facility.

One answer to spreading the burden of customer presence at an automobile facility is to extend business hours. However, this may entail additional costs in that more employees may be required to staff the facility during extended hours. Another answer is to automate certain aspects of operation, so that customers can initiate transactions at times when the facility is closed. This has been done to a limited extent for example by having service customers leave an automobile at a repair facility. Typically, a service customer places keys to the automobile along with a written description of a problem with the vehicle or of maintenance operations the customer wants performed in an envelope. The automobile and the envelope may then each be left in a designated location within the automobile facility.

While this system has been utilized for years, there remain certain problems with unstaffed after hours operations. One is that automobile dealerships, with their typical large inventory of old and new vehicles, present an enticement to vandals and thieves. Beyond actual vandalism and theft, even if there is no perception of potential trouble at the hands of vandals and thieves, customers may be intimidated by the size and desolation of a large scale automobile dealership, and thus may avoid after hours dropoffs and like activities. Therefore, both actual and perceived presence of vandals and thieves understandably discourage legitimate customers from availing themselves of after hours transactions.

Potential customers for new and old vehicles may wish to view available vehicles at the dealership, but may possibly be dissuaded should lighting be inadequate.

Automobile dealerships may discourage vandals and thieves by resorting to large scale floodlighting of the premises. While this may provide a certain measure of effectiveness, there remain several drawbacks to large scale lighting of premises. One of these is the cost of electricity, which may become significant considering that a number of relatively high wattage floodlights operating for many hours every night of the month may be necessary. A second drawback is that high levels of lighting may possibly be regarded by neighbors of the dealership as objectionable as an unwelcome intrusion, or as generating an industrial or harsh appearance in a neighborhood which might otherwise might have a softer or less harsh ambiance.

Automobile dealerships have an ongoing dilemma in balancing the competing demands of safety and security, economy, and sensitivity to the feelings of others in the community.

### SUMMARY OF THE INVENTION

The present invention provides a system for improving actual and perceived safety and security within an automobile dealership and encouraging after hours activities of actual and potential customers on the one hand, while minimizing costs and exposure of the environment to unnecessarily high light levels at night. The system monitors the premises for human activity after hours and takes appropriate actions to raise and lower lighting levels automatically, to identify and warn intruders of consequences, and to identify and assist customers who wish to conduct after hours activities.

The system automatically senses and greets potential customers who are on premises after hours. These potential customers are directed to certain facilities, such as an interactive data entry facility and locations to drop off automobiles for service and keys to the automobiles. The interactive data entry facility may accept data to initiate purchase and service transactions, and may establish live connection to remote security service personnel.

The system has appropriate sensors to detect anyone entering the premises after hours. The system may issue an audible request for identification. Should the response be determined to identify the people on premises as potential customers, the potential customers are directed to the interactive data entry facility and drop-off locations. Messages intended for those entering the premises may be delivered by speakers or on a dynamic screen of the interactive data entry facility.

The system may have a significant impact on limiting electrical consumption, while keeping exterior after hours illumination at levels appropriate for security, hospitality and helpfulness for customers, and intrusiveness of lighting as that affects lighting impinging on the surrounding community. Security may be enhanced by ability to discriminate between customers and undesirable intruders, and to summon assistance appropriately.

It is an object of the invention to provide a system which enhances security and encourages after hours business at an automotive facility.

Another object of the invention is to generate exterior illumination levels which are appropriate for prevailing conditions and to enjoy energy savings due to reduced illumination levels where appropriate.

A further object is to assist and enhance the interaction experience of after hours potential customers.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective view of an automotive facility which has been provided with an after hours exterior management system according to at least one aspect of the invention.

FIG. 2 is a diagram showing interrelationships of apparatus of both the automotive facility of FIG. 1 and optionally of remote facilities, which interrelationships pertain to a management system which according to at least one aspect of the invention controls and otherwise operates elements of the automotive facility of FIG. 1.

FIG. 3 is a block diagram summarizing steps of a method of practicing the invention, according to at least one further aspect.

### DETAILED DESCRIPTION

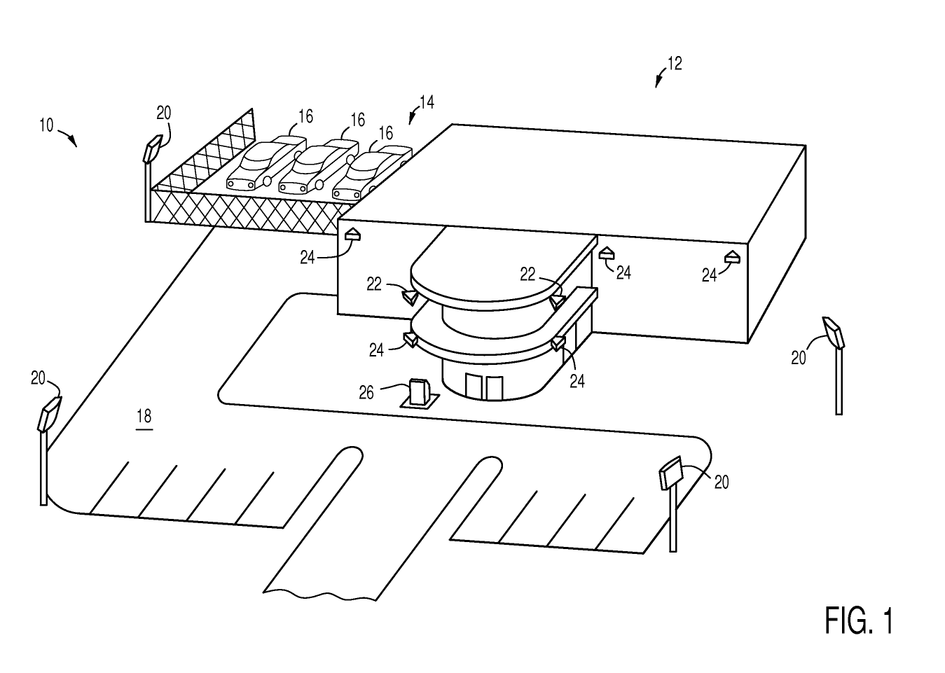

Referring first to FIG. 1, according to at least one aspect of the invention, there is shown an automotive facility 10 which is representative of automobile dealerships and service facilities. The automotive facility 10 may have a building 12 which is occupiable by personnel to conduct administrative aspects of business, a lot 14 on which vehicles 16 are stored and displayed for sale and lease or for repair and maintenance services, and interior space (not separately shown) within the building 12 for performing maintenance and repair services. the building 12 may comprise more than one building, including buildings which are detached from one another. Business which may be undertaken at the automotive facility 10 include but are not necessarily limited to sales of automobiles and accessories and replacement parts therefor, and leasing, servicing, and repairing automobiles. As the particular type of motor vehicles which may be sold, leased, repaired, and serviced is not critical, the term “automobile” will be understood to encompass not only private passenger cars, but also trucks and other transportation conveyances.

The automotive facility 10 may have a paved parking lot and driveway 18 which potential customers may use to park their automobiles while browsing for a new or old automobile to buy or lease, or while arranging for service or to buy replacement parts. The building 12, the lot 14, and the parking lot and driveway 18 may be illuminated at night by overhead lighting fixtures 20. Overhead lighting fixtures 20 are used representatively of any and all exterior lighting facilities, and represent ground mounted lighting fixtures, building mounted lighting fixtures, and all lighting fixtures which illuminate the parking lot and driveway 18, and any other exterior surfaces of the automotive facility 10. The parking lot and driveway 18 may be thought of as exterior grounds which are disposed proximate the building 12. The exterior grounds may also encompass land dedicated to activities of the automotive facility 10 other than just parking and operating a motor vehicle thereon. For example, the exterior grounds may be those used for vehicle storage, vehicle washing, staging, demonstrations and testing, and still other activities and functions. The term “proximate” does not necessarily imply a specified distance from the building 12. Rather, “proximate” signifies those exterior grounds which may be associated with the activities of the automotive facility 10 and are located in proximity thereto or by adjacency such that a casual observer would associate the building 12 (or buildings) with the automotive facility 10.

The automotive facility 10 may have one or more speakers 22 disposed to project sounds to the exterior grounds, and one or more intrusion sensors disposed to sense presence and absence of a person entering onto the exterior grounds, such as motion detectors 24. The automotive facility 10 may have a customer interface device for conducting automotive transactions in part or in their entirety at the automotive facility 10 when the automotive facility 10 is unstaffed, such as after ordinary business hours. The customer interface device may be in the form of a free-standing kiosk 26 having a memory device, a data processor, and communications capability. Specific components of the kiosk 26 are not shown. The nature of the kiosk may be that more fully described in the above referenced copending application.

Regardless of its specific nature, the kiosk 26 is disposed to be operable by a customer (not shown) to receive data entry to initiate a commercial transaction for an automobile purchase or lease transaction, or an automobile service request transaction.

The term “kiosk” has been introduced as a semantic convenience to connote a physical apparatus for providing an interface for customers and for entering, storing, and manipulating information into a digitized or corresponding data processing system. The term kiosk must therefore not be taken literally to signify a free standing booth or the like which contains the physical apparatus in a self-contained envelope. The interface elements and data processing system or systems may be integrated into a physical environment such as an automotive dealership, sales and/or leasing facility, or repair/service facility to any desired degree. The kiosk 26 is free-standing in that it may be mounted to any suitable environmental surface and may be unattached to the building 12 or other structure. In free-standing form, the kiosk 26 may conveniently be manufactured and installed on the premises of the automotive facility 10 as a modular unit to be installed after construction of the building 12, requiring only mounting in place and connection of communication and electrical power cables (not shown) to become functional. The purpose of the kiosk 26 is to enable customers to enter onto the premises of the automotive facility 10 and to initiate a transaction after hours when the personnel usually onsite are not present.

The automotive facility 10 is provided with an after hours exterior management system which provides certain benefits pertaining to illumination, security, and hospitality to customers and potential customers. As employed herein, the phrase “after hours” refers to times at which the automotive facility does not have personnel present to conduct transactions and perform services, or may have greatly reduced staffing by such personnel. These times may be after certain predetermined times of day, during holidays and days when the automotive facility 10 is ordinarily closed, and also may be irregular or unplanned times when the automotive facility is closed or has its ordinary activities fully or partially curtailed due to transient conditions such as adverse weather, failure of utilities, fires, and other disruptions to ordinary business activities. To this end, the after hours exterior management system typically provides its automated functions only after hours. However, the after hours exterior management system could be operated at other times, such as when so many customers are present that automated assistance by the after hours exterior management system is desired. Certain functions of the after hours exterior management system may be disabled or deactivated as may be appropriate at such times and if desired during hours when the after hours exterior management system is ordinarily in use.

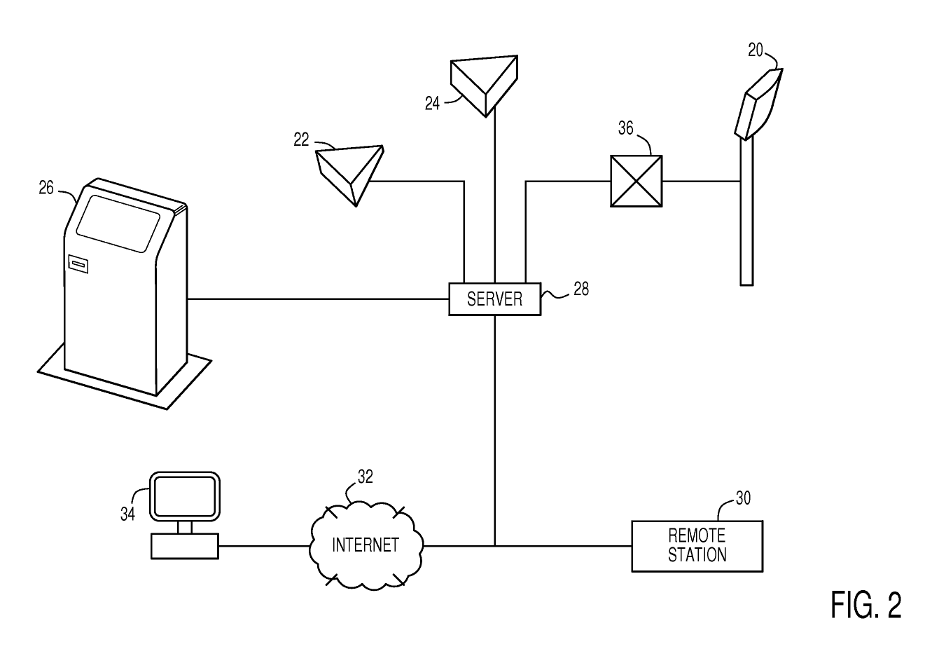

Referring now to FIG. 2, elements of the after hours exterior management system are shown. The overhead lighting fixtures 20, the speakers 22, the motion detectors 24, and the kiosk 26 may be placed in communication with a server 28 which may be located on the premises of the automotive facility 10 or which may be remote therefrom. In FIG. 2, overhead lighting fixtures 20, speakers 22, and motion detectors 24 are shown symbolically in the singular, but will be understood to represent plural devices where plural examples of these components are actually present in the automotive facility 10. Communication may signify hard wired connections, wireless links, and combinations thereof. Regardless of its location, the server 28 may be in communication with a remote central station 30 which may be for example a server or other data processing apparatus of a security system (not shown in its entirety). The security system may be for example an entity providing security services as a commercial service to the general public. The server 28 may also be in communication with the internet 32. The internet 32 may serve as a communications channel connecting the server 28 to a remote computer terminal such as a personal computer 34. Connection to the internet 32 may be utilized as a communications channel connecting the server 28 to the remote station 30 if desired.

The apparatus shown and described above may be utilized in one or both of two subsystems of the overall exterior management system.

One subsystem may comprise an illumination control system disposed to adjust exterior illumination lighting levels of the lighting fixtures 20 at the automotive facility 10. The illumination control system may control the overhead lighting fixtures 20 responsively to the motion detectors 24.

The illumination control system enhances security by selectively increasing illumination, and both implements significant utility cost savings and minimizes intrusion onto a surrounding neighborhood by selectively minimizing illumination. The illumination control system may operate for example by having a default lighting level for the overhead lighting fixtures 20. This default level may be the maximum lighting level attainable by the overhead lighting fixtures 20, or may be a lesser level. The illumination control system may control the level of lighting through a suitable controller 36. The controller 36 may be a voltage controller, a frequency controller, a pulse width modulator, or any other known controller, and may comprise one or more on-off switches (not separately shown) for controlling individual overhead lighting fixtures 20 independently of others. The controller 36 may comprise plural components each able to control fewer than all of the overhead lighting fixtures 20 simultaneously.

The controller 36 may be functional to operate any one or all of the overhead lighting fixtures 20 at more than two increments, such as at a maximum output level, a minimum output level, and an intermediate output level of magnitude between those of the maximum output level and the minimum output level. Illustratively, the intermediate output level may be of magnitude half that of the maximum output level, and the minimum output level may be of magnitude half that of the intermediate output level. Output levels may refer either to light output, as measured as lumens, or alternatively to electrical inputs.

The illumination control system may respond to the motion detectors 24 for example. Detection of a person or persons entering onto the exterior grounds 18 may cause the illumination control system to increase illumination levels. In the case of potential vandals and thieves, increased illumination and the realization that they have been detected may serve as an effective deterrent. In the case of actual or potential customers, increased illumination may enhance a feeling of safety and security, or may better display automobiles which are visible from the exterior grounds.

Lighting levels may be decreased in the absence of human presence both to conserve on utility costs and also to reduce intrusion onto surrounding neighborhoods.

A second subsystem may be a customer recognition system disposed to interact with a person who has been sensed by the motion detectors 24. The customer recognition system may be disposed to control the speakers 22 to issue at least one audible message, which audible message is directed to the person who has been sensed. To this end, the customer recognition system may utilize pre-recorded messages or synthetic voice messages for example, which are stored in the server 28. One of the messages may be a warning to a person who has been detected by the intrusion sensor that security measures are pending. Security measures, which may be made explicit in the warning message, may comprise advising and summoning private security personnel, or the police, or both.

The customer recognition system may be functional to establish a communications link to remote human security personnel, such as a person located at the premises of the remote station 30. The communications link may be telephonic in nature, and may rely on conventional telephonic technology, the internet 32 in known fashion, or may utilize any other known hardwired or wireless communications channel.

The customer recognition system may be functional to control the speakers 22 to audibly advise potential customers of a preferred location within the automotive facility to drop off automobiles for service, and where to drop off keys for automobiles left for service. Again, these messages may utilize pre-recorded or synthesized sounds.

The customer recognition system may be functional to control the speakers 22 to audibly advise potential customers of the existence and location of the kiosk 26, and may include elementary operating instructions, such as advising customers that the kiosk is interactive and uses a touch screen for example.

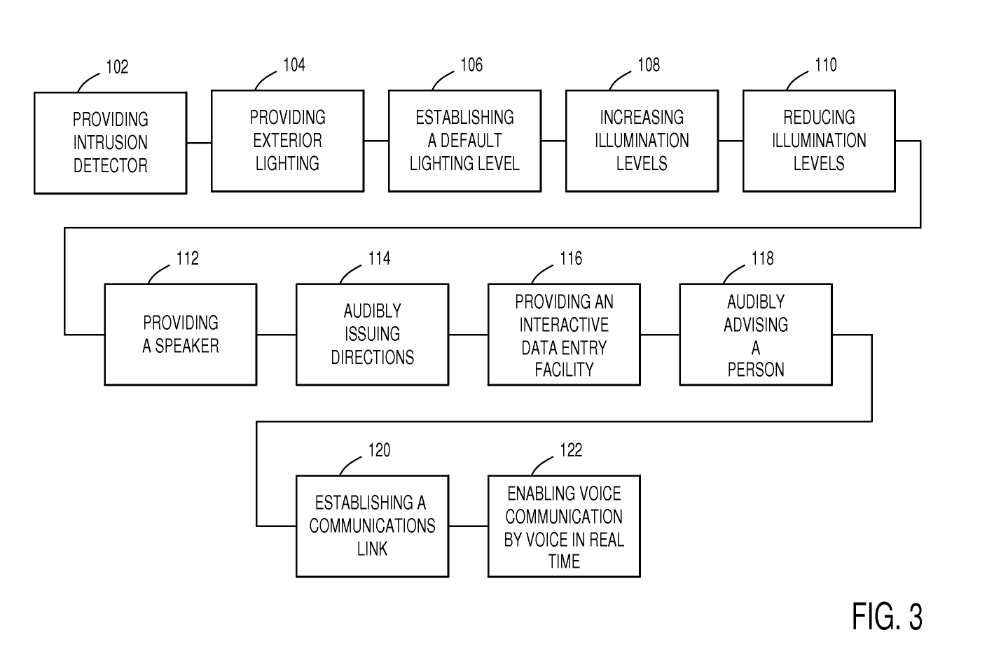

The invention may be thought of as a method 100 of managing the exterior of an automotive facility at times when operating personnel of the automotive facility are not on the premises, such as the automotive facility 10. Apparatus used in the steps of the method 100 may utilize the apparatus which has been described herein as applying to the automotive facility 10 even though the apparatus is not called out specifically by reference numeral. Referring now to FIG. 3, the method 100, is seen to comprise a step 102 of providing an intrusion sensor at the automotive facility; a second step 104 of providing exterior lighting sources such as the overhead lighting fixtures 20 at the automotive facility; a step 106 of establishing a default lighting level at which the exterior lighting sources are operated; a step 108 of increasing illumination levels of the exterior lighting sources responsively to detecting intrusion by the intrusion sensor after hours; and a step 110 of reducing illumination levels of the exterior lighting sources after hours responsively to not detecting intrusion by the intrusion sensor. It should be understood that increasing and decreasing illumination levels, as recited in the steps 108 and 110, may refer to modifying the last prevailing illumination levels, and not necessarily only those of the default levels.

The method 100 may comprise the further step 112 of providing a speaker at the automotive facility; and issuing a warning message to a person who has been detected by the intrusion sensor after hours. The step 112 may comprise a still further step 114 of issuing directions advising of available after hours facilities of the automotive facility to a person who has been detected by the intrusion sensor after hours. Usually, the kiosk 26 will be the after hours facility which is annunciated in the step 114, but drop off options may also provide examples of after hours facilities.

The method 100 may comprise another step 116 of providing an interactive data entry facility such as the kiosk 26 at the exterior of the automotive facility, and a further step 118 of audibly advising a person who has been detected by the intrusion sensor after hours of the existence and location of the interactive data entry facility.

The method 100 may comprise a still further step 120 of establishing a communications link between the interactive data entry facility and a remote security facility, and a step 122 of enabling a person using the interactive data entry facility to communicate by voice in real time with the remote security facility using the interactive data entry facility. That is, the interactive data entry facility may establish live audible contact, such as telephonic communications, between the customer and human personnel at the remote security facility.

As employed herein, the terms “communication” and “connection” will be understood to include all conventional components, apparatus, and interconnections necessary to accomplish the specified functions.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. An automotive facility having an after hours exterior management system, comprising:
a building which is occupiable by personnel for the purposes of conducting at least one of sales, leasing, servicing, and repairing automobiles;
exterior grounds disposed proximate the building;
an interactive interface operable by a customer to initiate an automotive related commercial transaction located on the exterior grounds;
at least one lighting fixture disposed to illuminate the exterior grounds;
at least one speaker disposed to project sound to the exterior grounds;
at least one intrusion sensor disposed to sense presence and absence of a person entering onto the exterior grounds;
an illumination control system disposed to adjust exterior illumination lighting levels of the lighting fixture at the automotive facility responsive to the intrusion sensor sensing presence and absence of persons entering onto the exterior grounds; and
a customer recognition system disposed to interact with a person who has been sensed by the intrusion sensor, wherein the customer recognition system is disposed to issue at least one audible message by the speaker, which audible message is directed to the person who has been sensed.

2. The automotive facility having an after hours exterior management system of claim 1, wherein the illumination control system is functional to operate any one of the at least one lighting fixture selectively at a maximum output level, at a minimum output level, and at an intermediate output level which is between the maximum output level and the minimum output level.

3. The automotive facility having an after hours exterior management system of claim 2, wherein the intermediate output level is of magnitude half that of the maximum output level, and the minimum output level is of magnitude half that of the intermediate output level.

4. The automotive facility having an after hours exterior management system of claim 1, wherein the customer recognition system is functional to control the speaker to issue a warning to a person who has been detected by the intrusion sensor that security measures are pending.

5. The automotive facility having an after hours exterior management system of claim 1, wherein the customer recognition system is functional to control the speaker to audibly advise potential customers of a preferred location within the automotive facility to drop off automobiles for service.

6. The automotive facility having an after hours exterior management system of claim 5, wherein the customer recognition system is functional to control the speaker to audibly advise potential customers of a preferred location within the automotive facility to drop off keys for automobiles left for service.

7. The automotive facility having an after hours exterior management system of claim 1, wherein the customer recognition system is functional to control the speaker to audibly advise potential customers of the existence and location of the interactive interface.

8. The automotive facility having an after hours exterior management system of claim 1, wherein the interactive interface is functional to establish a communications link to remote human security personnel.

9. A method of managing the exterior of an automotive facility at times when operating personnel of the automotive facility are not on the premises, comprising the steps of:
providing an intrusion sensor at the automotive facility;
providing exterior lighting sources at the automotive facility;
establishing a default lighting level at which the exterior lighting sources are operated;
increasing illumination levels of the exterior lighting sources responsively to detecting intrusion by the intrusion sensor after hours; and
reducing illumination levels of the exterior lighting sources after hours responsively to not detecting intrusion by the intrusion sensor.

10. The method of claim 9, comprising the further steps of:
providing a speaker at the automotive facility; and issuing a warning message to a person who has been detected by the intrusion sensor after hours.

11. The method of claim 9, comprising the further steps of:
providing a speaker at the automotive facility; and
issuing directions advising of available after hours facilities of the automotive facility to a person who has been detected by the intrusion sensor after hours.

12. The method of claim 11, comprising the further steps of:
providing an interactive data entry facility at the exterior of the automotive facility; and
audibly advising a person who has been detected by the intrusion sensor after hours of the existence and location of the interactive data entry facility.

13. The method of claim 12, comprising the further steps of:
establishing a communications link between the interactive data entry facility and a remote security facility; and
enabling a person using the interactive data entry facility to communicate by voice in real time with the remote security facility using the interactive data entry facility.
